(19) United States
(12) Patent Application Publication
(10) Pub. No.: US 2020/0396519 A1
(43) Pub. Date: Dec. 17, 2020

(54) METHOD FOR INTERACTING WITH A SUBTITLE DISPLAYED ON A TELEVISION SCREEN, DEVICE, COMPUTER PROGRAM PRODUCT AND RECORDING MEDIUM FOR IMPLEMENTING SUCH A METHOD

(71) Applicant: SAGEMCOM BROADBAND SAS, RUEIL MALMAISON (FR)

(72) Inventor: Gilles BARDOUX, RUEIL MALMAISON (FR)

(21) Appl. No.: 16/768,343

(22) PCT Filed: Nov. 29, 2018
(86) PCT No.: PCT/EP2018/082930

§ 371 Date: May 29, 2020

(30) Foreign Application Priority Data
Dec. 8, 2017 (FR) 1761872

(51) Int. Cl. H04N 21/488; G06F 3/01; G10L 15/22; G10L 15/08; G06F 3/16; H04N 21/422; H04N 21/485; H04N 21/472

(52) U.S. Cl. CPC H04N 21/4884; G06F 3/017; G10L 15/22; G10L 15/08; G10L 2015/223; H04N 21/42203; H04N 21/4856; H04N 21/47217; G10L 2015/088; G06F 3/167

(57) ABSTRACT

A method for interacting with a subtitle displayed in a display area of a digital television screen, the method including a calibration procedure and a procedure for interactively displaying a subtitled video on the digital television screen.

### TECHNICAL FIELD OF THE INVENTION

The technical field of the invention is that of interaction with a subtitle displayed on a digital television screen.

The present invention relates in particular to a method for interacting with a subtitle displayed in a display area of a digital television screen. The present invention also relates to a device, a computer program product and a recording medium for implementing such a method.

### TECHNOLOGICAL BACKGROUND OF THE INVENTION

In the field of learning languages, a conventional solution is to propose a static and continuous display of the subtitles in two languages, typically the mother tongue and the foreign language in the process of being learned, which allows the user to have the translation of all the words of the foreign language into his native tongue. However, this contributes to overloading the image on the screen while still delivering translations which are not always necessary for the comprehension of the user.

Moreover and in general, the existing solutions only allow the user to define subtitle display parameters such as the size, colour or the font type. This defining typically takes place a single time before the beginning or at the beginning of the broadcast of the subtitled video.

There is a need for the user to interact with subtitles during the broadcast of the subtitled video in order to obtain additional information or to carry out actions in a targeted and personalised way which does not systematically degrade the viewing.

### SUMMARY OF THE INVENTION

The invention offers a solution to the problems mentioned hereinabove, by allowing a user to interact with a subtitle of a video in such a way as to carry out targeted and personalised actions that precisely meet the needs of the user without systematically reducing the viewing quality.

An aspect of the invention relates to a method for interacting with a subtitle displayed in a display area of a digital television screen, the display area having a first dimension X and a second dimension Y distinct from the first dimension X, the method comprising:
a calibration step in which:
   a computer displays a first point of coordinates (x₁; y₁) in the display area; a camera produces a first film of an environment and transmits the first calibration film to the computer; the computer records the first calibration film, detects a first position of a finger of a user in the first calibration film and associates the first detected position with the first point;
   the computer displays a second point of coordinates (x₂; y₂) in the display area, the coordinates (x₂; y₂) being such that x₂ is different from x₁ and y₂ is different from y₁; the camera produces a second calibration film of the environment and transmits the second calibration film to the computer; the computer records the second calibration film, detects a second position of a finger of the user in the second calibration film, the second position being different from the first position, and associates the second detected position with the second point;
   the computer computes a correspondence between the display area of the screen and an interaction area of the user;
a step of interactively displaying a subtitled video on the digital television screen in which the subtitled video is displayed on the digital television screen and:
   the camera produces a film of the environment and transmits the film in real time to the computer; the computer records the film and detects a presence of a finger of the user in the film; and/or
   a microphone picks up a sound environment in the form of a signal and transmits the signal to the computer; the computer records the signal and detects a keyword in the signal.

Thanks to the invention, the computer determines all the positions in which the finger of a user can be when it is pointing to any point of the display area, thus defining an interaction area of the user. Thanks to the defining of his interaction area, the user interacts with a subtitle of the video that he is watching by a few finger movements coupled or not with a voice command. In addition, as the computer can be integrated into a digital television decoder, the method can be implemented using an inexpensive device since each household is generally equipped with a decoder, a camera and a microphone, which are furthermore inexpensive equipment.

In addition to the characteristics that have just been mentioned in the preceding paragraph, the method according to an aspect of the invention can have one or several additional characteristics among the following, taken individually or according to any technically permissible combination.

Advantageously, the display area is a quadrilateral and the first point and the second point are two corners of the display area located diagonally.

Thus, two corners of the display area are points that are easy for a user to point to and the fact that they are diagonal makes it possible to directly compute the length and the height of the interaction area of the user.

Advantageously, during the calibration step, the computer displays a third point distinct from the first and from the second point; the camera produces a third calibration film of the environment and transmits the third calibration film to the computer; the computer records the third calibration film, detects a third position of a finger of the user in the third calibration film, the third position being different from the first and from the second position, and associates the third detected position with the third point.

Thus, the reading of the position of a third point makes it possible to improve the calibration if the user is not in front of the television screen but sideways: the plane of the interaction area of the user is then not parallel to the plane of the display area of the subtitles.

Advantageously, the third point is the centre of the display area. Thus, the reading of the position of the centre of the display area facilitates the management of the perspective.

Advantageously, during the calibration step, when the position pointed to by the user is read, the position of the finger of the user does not vary in absolute value by more than a certain threshold for a certain interval of time.

Thus, this prevents incorrect calibration or excessive sensitivity, for example caused by an abrupt movement of the user.

Advantageously, the step of interactively displaying comprises a pausing of the video followed by a resuming of the video or of a selection of one or several words of a subtitle displayed on the screen.

Thus, the video is put on pause and the user has the time to carry out an action and in particular to select one or several words without losing track of his viewing.

Advantageously, the pausing of the video is carried out by a gestural command according to which the computer detects a presence of a finger of the user in the film.

Thus, a simple and quick movement of the finger stops the video.

Advantageously, the pausing takes place when the position of the finger of the user is read in the subtitle area of the television for a certain interval of time.

Thus, this prevents untimely stoppings of the video caused by involuntary gestures of the user.

Advantageously, the pausing of the video is carried out by a voice command according to which the microphone picks up the sound environment in the form of a signal and transmits the signal to the computer, the computer records the signal and detects a keyword for pausing.

Thus, the user only has to pronounce a keyword allowing him to stop the video and does not have to point to the display area.

Advantageously, the step of selecting is carried out by a gestural command according to which the computer detects in the film a first prolonged stop of a finger of the user in a first position of the display area. Thus, selecting a word is simple and quick.

Advantageously, in the gestural command, the computer detects in the film the first prolonged stop followed by a movement then a second prolonged stop of a finger of the user in a second position of the display area, the first and second positions being separate or merged. Thus, selecting several words is simple and quick and the user does not have to point to the words one by one.

Advantageously, the step of selecting is carried out by the gestural command only or by a combination of the gestural command and a voice command according to which the microphone picks up the sound environment in the form of a signal and transmits the signal to the computer and the computer records the signal and detects a keyword for selecting.

Thus, the user can, for example, request to start his selection again without having to point to the option.

Advantageously, the step of interactively displaying comprises a validation of the selection made by a gestural command according to which the computer detects in the film a prolonged stop of a finger of the user in a validation area.

Thus, a simple and quick movement of the finger validates the selection.

Advantageously, the step of interactively displaying comprises a validation of the selection made by a voice command according to which the microphone picks up the sound environment in the form of a signal and transmits the signal to the computer and the computer records the signal and detects a keyword for validating.

Thus, the user only has to pronounce a keyword that allows him to validate the selection and does not have to point to the validation area.

Advantageously, the step of interactively displaying comprises the choosing of an action to be carried out with the selection made by a gestural command according to which the computer detects in the film a prolonged stop of a finger of the user in an action area.

Thus, choosing the action to be carried out is simple and quick.

Advantageously, the step of interactively displaying comprises the choosing of an action to be carried out with the selection made by a gestural command according to which the computer detects in the film a particular gesture that corresponds to an action to be carried out.

Thus, the user does not have to point to an action area. As a particular sign is associated with a possible action, it is sufficient for him to make the sign that corresponds to the action that he wishes to carry out.

Advantageously, the step of interactively displaying comprises the choosing of an action to be carried out with the selection made by a voice command according to which the microphone picks up the sound environment in the form of a signal and transmits the signal to the computer and the computer records the signal and detects a keyword for an action to be carried out.

Thus, the user only has to pronounce a keyword that allows him to choose the action to be carried out and does not have to point to the action area.

Advantageously, the action to be carried out with the previously selected word or words is preconfigured by the user.

Thus, the user does not need to choose the action to be carried out, the same action will be applied to all the selections.

Advantageously, pointing is improved by adding a visual aid on the screen. Thus, a user can see on the screen the current position that is estimated for the pointing of his finger, which makes pointing easier for him.

Advantageously, the step of interactively displaying comprises returning to the selection screen by a gestural command according to which the computer detects a prolonged stop of a finger of the user in a return area.

Thus, the returning to the selection screen is simple and quick.

Advantageously, the step of interactively displaying comprises the returning to the selection screen by a gestural command according to which the computer detects in the film a particular gesture which corresponds to returning to the selection screen.

Thus, the user does not need to point to the return area. As a particular sign is associated with returning to the selection screen, it is sufficient for him to make the corresponding sign.

Advantageously, the step of interactively displaying comprises the returning to the selection screen by a voice command according to which the microphone picks up the sound environment in the form of a signal and transmits the signal to the computer and the computer records the signal and detects a keyword for returning.

Thus, the user only has to pronounce a keyword that allows him to return to the selection screen and does not have to point to the return area.

Advantageously, the step of interactively displaying includes the resuming of the video by a gestural command according to which the computer detects in the film a prolonged stop of a finger of the user in a resuming area.

Thus, the resuming of the video is simple and quick.

Advantageously, the step of interactively displaying includes the resuming of the video by a gestural command according to which the computer detects in the film a particular gesture corresponding to the resuming of the video.

Thus, the user does not need to point to the resuming area. As a particular sign is associated with the resuming of the video, it is sufficient for him to make the corresponding sign.

Advantageously, the step of interactively displaying includes the resuming of the video by a voice command according to which the microphone picks up the sound environment in the form of a signal and transmits the signal to the computer and the computer records the signal and detects a keyword for resuming. Thus, the user only has to pronounce a keyword that allows him to resume the video and does not have to point to the resuming area.

A second aspect of the invention relates to a device for interacting with a subtitle displayed in a display area of a digital television screen, characterised in that it comprises a computer and a camera, the camera comprising means for producing films and for transmitting them to the computer, the computer comprising:
means for displaying on the digital television screen,
means for receiving and recording films transmitted by the camera,
means for processing images and computing.

Advantageously, the camera is integrated into the computer.

Thus, the device for implementing the method is more compact.

Advantageously, the camera is connected to the computer. Thus, the user can use a camera that he already has and connect it to the computer.

A third aspect of the invention relates to a computer program product comprising instructions which, when the program is executed by a computer, lead the latter to implement the method according to a first aspect of the invention.

A fourth aspect of the invention relates to a recording medium that can be read by a computer comprising instructions which, when they are executed by a computer, lead the latter to implement the method according to a first aspect of the invention.

The invention and the various applications thereof will be understood better when reading the following description and examining the accompanying figures.

### BRIEF DESCRIPTION OF THE FIGURES

The figures are provided for the purposes of information and in no way limit the invention.

FIG. 1 shows a flow diagram that diagrammatically shows the method according to a first aspect of the invention.

FIG. 2 diagrammatically shows the calibration step of the method according to a first aspect of the invention.

FIGS. 3A and 3B diagrammatically show of the selection step of the method according to a first aspect of the invention.

### DETAILED DESCRIPTION OF AT LEAST ONE EMBODIMENT OF THE INVENTION

Unless mentioned otherwise, the same element appearing in different figures has a unique reference.

A first aspect of the invention relates to a method 100 for interacting with a subtitle displayed in a display area Z_{A} of a digital television screen. In the present application, the word subtitle must be understood as all of the overprinted text of an image extracted from a video at a given instant: it can therefore be formed of one or several words.

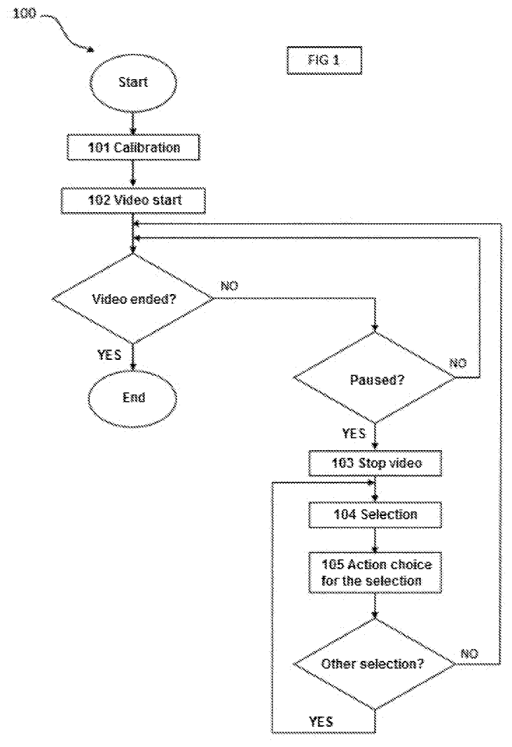

The method 100 according to a first aspect of the invention includes several steps, the sequence of which is shown in FIG. 1. These steps are implemented by a computer Dec coupled to a camera Cam and optionally to a microphone. In the present application, the word computer Dec refers to a device that has a memory, image processing functions in order to carry out the monitoring of one or several fingers of one or several users in the films coming from the camera and signal processing functions in order to detect keywords in a sound recording. Preferably, the computer is integrated within a digital television decoder able to decode encrypted television signals.

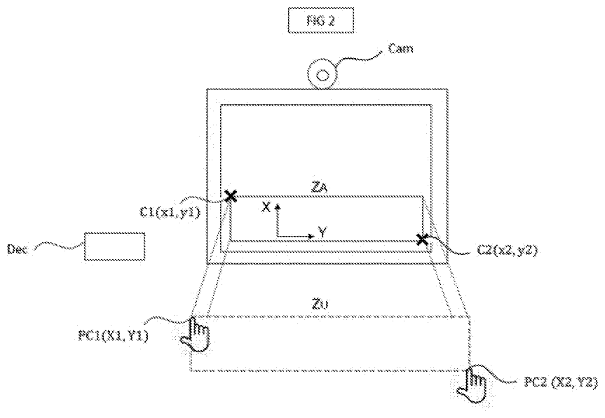

The first step is the calibration step 101 shown in FIG. 2. This step makes it possible to have the display area Z_{A} correspond to an interaction area of the user Zᵤ. The interaction area of the user Zᵤ comprises all the positions in which the finger of a user can be when it is pointing to any point of the display area Z_{A}.

This calibration step 101 can be carried out by several users at the same time or one after the other. Thus, each user has his own interaction area Zᵤ, that takes his position into account in relation to the digital television screen. During this step, the computer Dec displays a first point C1 on the display area Z_{A}. The term point means a point in the mathematical sense of the term or the centre of an area can have for example, a circular, square or cross shape. The camera Cam is then turned on by the computer or by the user, records a first calibration film and transmits it to the computer. Generally, the term film means an image or a plurality of images. The computer Dec detects a finger of a user in the first calibration film, records a first position PC1 of this finger and associates it with the position of the first point C1. The camera Cam then records a second calibration film and transmits it to the computer, which detects a finger of the user in the second calibration film, records a second position PC2 of this finger and associates it with the position of the second point C2. The first and second calibration films can be two separate films, with the camera interrupting itself after the calibration of the first point C1 and resuming for the calibration of the second point C2, or two subverts of a single film, with the camera continuously filming during the entire step of calibration.

The calibration step 101 can be carried out with a higher number of points, for example three points. The display area Z_{A} is preferably a quadrilateral and more preferably a rectangle. It has a first dimension X and a second dimension Y which define a 2D coordinate system XY. The three points can for example be the upper-left corner, the lower-right corner and the centre of the display area Z_{A}; the reading of the position of the centre of the display area Z_{A} facilitating the management of the perspective.

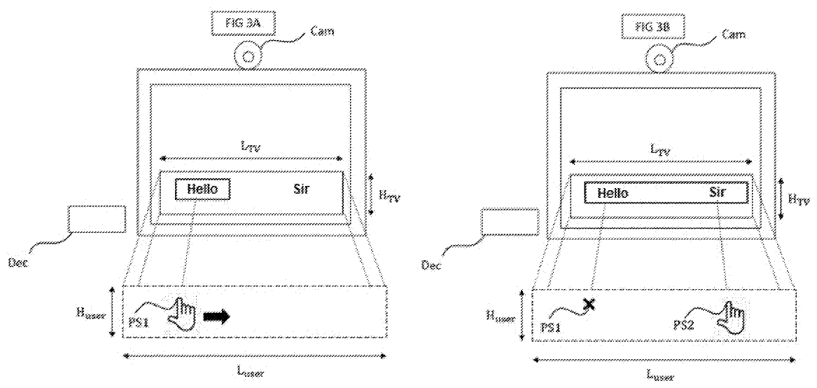

Two points are enough if their two coordinates in the coordinate system XY are different. However, the calibration is better when at least three points are used. Indeed, the first two points are used to compute the height Hᵤₛₑᵣ according to the dimension X and the length Luster according to the dimension Y of the interaction area of the user Zᵤ. This area is shown as a dotted line, in the foreground in FIGS. 3A and 3B. However, if the user is not in front of the television, the plane of the interaction area of the user Zᵤ may not be parallel to the plane of the display area Z_{A}: the reading of the position of a third point then makes it possible to evaluate an angle between the plane of the interaction area of the user Zᵤ and the plane of the display area Z_{A}. Generally, the higher the number of points to be pointed to is, the more robust the calibration is. The impact of the depth on the horizontal and vertical movements of the finger of the user is negligible as long as the variation in depth is small in terms of the television-user distance. During the calibration step 101, a monitoring is set up in order to detect a presence of a finger of the user and read its position. This monitoring can be carried out by using, for example a Kaufman filter or a recursive Gauss-Newton filter. Preferably, the computer reads the position of a point when the position of the finger of the user pointing towards the point on which it is desired to read the position has not varied by more than a certain threshold A in absolute value for an interval of time T. Indeed, it is considered that the finger is pointing to the definitive position (X₀, Y₀) if the following condition is satisfied:

∀t−t₀<T:d((X(t), Y(t)), (X₀, Y₀))<Δ

Where d is the Euclidean distance operator, t₀ is the instant when the monitored position of the finger is that chosen as the one pointing to the point of which of which it is desired to read the position, X₀=X(t₀) is the abscissa in t₀ and Y₀=Y(L₀) is the ordinate of t₀. The position (X₀, Y₀) is then recorded and then the position of the following point is read. The threshold Δ can, for example, be 5 cm. The interval of time T can, for example be comprised in the interval [1 s; 2 s].

Once the positions of the two points PC1 and PC2 have been read, the computer Dec associates these two positions respectively with the points C1 and C2 which allows it to compute a correspondence between the display area Z_{A} and the interaction area of the user Zᵤ. At the end of the calibration step 101, each point of the display area Z_{A} is in correspondence with a point of the interaction area of the user Zᵤ.

Once the calibration step 101 is complete, the step of interactively displaying begins. The monitoring of the finger preferably starts at the same time as video but could also start before. Indeed, the monitoring is carried out continuously during the video by using, for example, a Kaufman filter or a recursive Gauss-Newton filter on the film taken by the camera Cam. Preferably, the camera Cam has already been turned on by the computer or by the user at the beginning of the calibration step and has been filming since then but it may also have been turned off at the end of the calibration step and turned back on at the beginning of the step of interactively displaying. In all cases, the camera begins filming at the beginning of the step of interactively displaying. The film during the step of interactively displaying can be distinct from the calibration film or films, with the camera interrupting itself after the calibration step and resuming during the step of interactively displaying, or the film of the step of interactively displaying and the calibration film or films can be several subverts of the same film, with the camera filming continuously. The video continues normally as long as there is no pausing 103.

The step of interactively displaying can be carried out by several users by setting up a monitoring for each user.

According to an embodiment, for pausing, the computer Dec must detect the presence of a finger of the user in the display area Z_{A}. Preferably, the computer pauses the video when the position of the finger of the user has not varied by more than a certain threshold Δ2 in absolute value for an interval of time T₂. The threshold Δ₂ can be the same or different from the threshold Δ. The threshold Δ₂ can, for example be 10 cm. This interval of time T₂ can be the same or different from the interval of time T. The interval of time T₂ can, for example be within the interval [0.5 s; 1.5 s].

According to another embodiment, a microphone picks up the sound environment in the form of a signal and transmits it to the computer Dec. If a keyword is pronounced, the detector pauses the video 103. This keyword can be, for example “pause”.

Detecting keywords can for example be carried out by a dynamic programming algorithm based on a time standardization or a WUW algorithm (for “Wake-Up-Word”).

Once paused 103, the video stops. According to an embodiment, in order to select one or several words 104, a finger of the user marks a single stop in the display area Z_{A}. The position pointed to on the screen is estimated using the position of the finger filmed by the camera Cam and data obtained during the calibration step 101. Indeed, the height Huber and the length Luster of the interaction area of the user

Zᵤ make it possible to compute a horizontal sensitivity coefficient a and a vertical sensitivity coefficient β with the following formulas:

$$α = \frac{{L}_{TV}}{{L}_{user}}$$

$$β = \frac{{H}_{TV}}{{H}_{user}}$$

Where L_{TV} is the length of the display area Z_{A} and H_{TV} is the height of the display area Z_{A}. The display area Z_{A} is always the same, for example the lower quarter of the television. In addition, the position of each point of the display area Z_{A} pointed to during the calibration step 101 is associated with the position of the finger that is pointing to it. Thus, the position of the point C1(X₁, Y₁) of the display area Z_{A} pointed to during the calibration step 101 is associated with the position PC1(X₁, Y₁) of the finger pointing to this point. If the position of the finger filmed by the camera Cam is estimated at (X₁+ex, Y₁+dye), the position pointed on the screen will be (x₁+α*ex, y₁+β*dye). As each word virtually corresponds to a rectangle on the screen, the rectangle that corresponds to the position (x₁+α* ex, y₁+α*dye) is selected. This case is shown in FIG. 3A. The user moves his finger in the interaction area Zᵤ shown as a dotted line, with height Hᵤₛₑᵣ and length Lᵤₛₑᵣ. A correspondence is established between the position of the finger of the user and a position on the screen close to the word “hello” which is thus selected. Preferably, the computer reads the position (X₁+ex, Y₁+dye) when the position of the finger of the user has not varied by more than a certain threshold in absolute value for a certain interval of time. This threshold can be the same or different from the threshold Δ and/or threshold Δ₂. This interval of time can be the same or different from the interval of time T and/or the interval of time T₂.

By marking a single stop in the display area Z_{A}, the user can select several words if for example, the computer is configured to select one or several words adjacent to the word point to or if the gestural command is used in combination with a voice command, for example, the user says “two” to select the pointed word and the following two words.

According to another embodiment, in order to select one or several words 104, the finger of the user carries out a movement after the first prolonged stop and marks a second stop once the movement is completed. If the position of the first prolonged stop is different from that of the second prolonged stop, the computer preferably interprets the fact that the finger is pointing to the location of the beginning of the selection then to the location of the end of the selection. This case is shown in FIGS. 3A and 3B. The user moves his finger in the interaction area Zᵤ. In FIG. 3A, the finger marks a first stop at the position PS1 which is pointing to a first word “hello”. The first word “hello” is then selected which is materialized by a framing of the word. The finger then carries out a linear movement before marking a second stop at the position PS2 which is pointing to a second word “sir” in FIG. 3B. The second word is then added to the selection which is materialized by an enlarging of the preceding framing in order to encompass both words. The first and second words can follow one another or be separated by one or several other words. The computer is able to draw a framing or an outline area by selecting all the words between the first and the second word even if the first and the second word are not on the same subtitle line. If the position of the first prolonged stop is the same as that of the second prolonged stop, the computer preferably interprets the case where the finger of the user has surrounded the selection.

In parallel, keywords pronounced by a user and recorded by a microphone can make it possible for example to start, restart or finish the drawing of the outline area of the word or words to be selected. A keyword can be for example “restart”.

Advantageously, the step of selecting is carried out at least partially by a gestural command, which procures better comfort for the user by avoiding a meticulous and/or difficult step, for example saying a word for which he is not sure of the pronunciation with the risk that his command will not be understood by the computer, or counting the position of the first word that he wishes to select then counting the position of the last word that he wishes to select or counting the number of words in the selection. Thus, it is made possible for the duration of the step of selecting to be significantly reduced and this contributes to the user keeping track of his viewing. In addition, the gestural commands are more robust than voice commands: in order to detect a keyword, the background noise has to be sufficient low and preferably no one else other than the user should speak at the risk of triggering unwanted commands. In particular, the voice command is poorly adapted to a multiuser mode. On the contrary, introducing a gestural command makes it possible to provide a starting point for the selection, making it more precise and faster even when combined with a voice command, which makes it possible to not degrade the viewing.

In order to improve the pointing, a visual aid can be added as overprint on the screen in order to indicate to the user what is the current estimated position for the pointing of his finger. This visual aid can for example be a point of colour, for example red or green. Each user can have a pointer with a different colour. This visual aid can be set up from the starting of the video 102 or only when the video is paused 103.

Once the selection 104 is complete, it is validated by the user. According to an embodiment, the validation is carried out via a gestural command. For example, the user points to a validation area that is a portion of the display area Z_{A} where for example the word “validation” is indicated.

According to another embodiment, the validation is carried out via a voice command. For example, the user pronounces the keyword “validation”.

Once the selection 104 is validated, several actions can be carried out with the selected word or words such as for example a translation or the adding of the selection to a list accompanied with data concerning for example, the video from which it was extracted or the moment in the video when it was extracted. According to a first embodiment, a list of options of actions is displayed on the screen, with each option having an action area being a portion of the display area Z_{A}. A finger of the user marks a stop on the action area that corresponds to the action that he wishes to carry out with the previously validated selection. Several actions can be selected successively.

According to a second embodiment, each action is associated with a particular gesture, for example lifting the thumb correspond to a translation of the selection. Therefore the gesture associated with the action must be made in order to choose to carry out this action.

According to a third embodiment, an action keyword is pronounced. For example, the user pronounces the keyword “translation”.

According to a fourth embodiment, an action was preconfigured beforehand and this action will therefore be carried out automatically for each selection.

For each action carried out, a confirmation message of the execution of the action can appear on the screen.

Once the chosen actions 105 have been carried out, the choice is made to return to the selection screen or to resume the video.

To return to the selection screen:
according to a first embodiment, a finger of the user marks a stop on a return area being a portion of the display area Z_{A} where for example the word “return” is indicated;
according to another embodiment, the return is carried out via a voice command. For example, the user pronounces the keyword “return”.

Once the selection screen has returned, a second selection can be carried out by carrying out the same steps as hereinabove.

To resume the video:
according to a first embodiment, a finger of the user marks a stop on a resuming area being a portion of the display area Z_{A} where for example the word “resume” is indicated;
according to another embodiment, the resuming is carried out via a voice command. For example, the user pronounces the keyword “resume”.

The video then resumes from where it had stopped.

All of the steps described hereinabove are implemented by the second aspect of the invention which relates to a device comprising a computer Dec and a camera Cam.

The computer Dec is connected to a television by a wired or wireless connection which allows it to display instructions on a digital television screen.

According to an embodiment, the computer Dec is connected to the camera Cam by a wired or wireless connection.

According to another embodiment, the camera Cam is integrated into the computer Dec. The camera Cam can for example be a webcam. The camera Cam films the environment and transmits images to the computer Dec which is able to receive the films and record them.

The computer Dec can also be connected to a microphone by a wired or wireless connection. The microphone picks up its sound environment in the form of signals and transmits them to the computer Dec in digital format. The computer Dec is able to receive the signal and record it.

The computer has image processing functions in order to carry out the monitoring of one or of several fingers of one or several users as well as signal processing functions in order to detect keywords in a sound recording.

The third aspect of the invention relates to a computer program product that makes it possible to implement the method 100 according to a first aspect of the invention.

The computer program product allows for the displaying of instructions on the television screen in order to carry out steps. For example, it displays on the screen the points that must be pointed to during the calibration step 101. It also carries out the monitoring of the fingers of the users and the detecting of keywords.

The fourth aspect of the invention relates to a recording medium on which the computer program product according to a third aspect of the invention is recorded.

1. A method for interacting with a subtitle displayed in a display area of a digital television screen, the display area having a first dimension X and a second dimension Y distinct from the first dimension X, the method comprising:
a calibration step in which:
a computer displays a first point of coordinates (x₁; y₁) in the display area; a camera produces a first calibration film of an environment and transmits the first calibration film to the computer; the computer records the first calibration film, detects a first position of a finger of a user in the first calibration film and associates the first detected positioner with the first point;
the computer displays a second point of coordinates (x₂; y₂) in the display area, the coordinates (x₂; y₂) being such that x₂ is different from x₁ and y₂ is different from y₁; the camera (Cam) produces a second calibration film of the environment and transmits the second calibration film to the computer; the computer records the second calibration film, detects a second position of a finger of the user in the second calibration film, the second position being different from the first position, and associates the second detected position with the second point;
the computer computes a correspondence between the display area and an interaction area of the user;
a step of interactively displaying a subtitled video on the digital television screen in which the subtitled video is displayed on the digital television screen and:
the camera produces a film of the environment and transmits the film to the computer; the computer records the film and detects a presence of a finger of the user in the film; and/or
a microphone picks up a sound environment in the form of a signal and transmits the signal to the computer; the computer records the signal and detects a keyword in the signal.

2. The method according to claim 1, wherein the step of interactively displaying comprises a pausing of the video followed by a resuming of the video or of a selection of one or several words of a subtitle displayed on the screen.

3. The method according to claim 2, wherein the pausing of the video is carried out:
by a voice command according to which the microphone picks up the sound environment in the form of a signal and transmits the signal to the computer;
the computer-Pee) records the signal and detects a keyword for pausing; or
by a gestural command according to which the computer detects a presence of a finger of the user in the film.

4. The method according to claim 2, wherein the step of selecting is carried out by a gestural command according to which the computer detects in the film a first prolonged stop of a finger of the user in a first position of the display area.

5. The method according to claim 4, wherein in the gestural command, the computer-Pee) detects in the film the first prolonged stop followed by a movement then a second prolonged stop of a finger of the user in a second position of the display area, the first and second positions being distinct or merged.

6. The method according to claim 4 wherein the step of selecting is carried out by the gestural command only or by a combination of the gestural command and a voice command according to which the microphone picks up the sound environment in the form of a signal and transmits the signal to the computer and the computer records the signal and detects a keyword for selecting.

7. The method according to claim 2, wherein the step of interactively displaying comprises a validation of the selection made:
by a gestural command according to which the computer detects in the film a prolonged stop of a finger of the user in a validation area; or
by a voice command according to which the microphone picks up the sound environment in the form of a signal and transmits the signal to the computer and the computer records the signal and detects a keyword for validating.

8. The method according to claim 2, wherein the step of interactively displaying comprises the choosing of an action to be carried out with the selection made:
by a gestural command according to which:
the computer detects in the film a prolonged stop of a finger of the user in an action area; or
the computer detects in the film a particular gesture that corresponds to an action to be carried out; or
by a voice command according to which the microphone picks up the sound environment in the form of a signal and transmits the signal to the computer and the computer records the signal and detects a keyword for an action to be carried out.

9. A device for interacting with a subtitle displayed in a display area of a digital television screen, the device comprising a computer and a camera, the camera comprising means for producing films and for transmitting them to the computer, the computer comprising:
means for displaying on the digital television screen,
means for receiving and recording films transmitted by the camera (Cam),
means for processing images and computing.

10. A computer program product comprising instructions which, when the program is executed by a computer, lead the computer to implement the method according to claim 1.

11. A non-transitory recording medium that can be readable by a computer and comprising instructions which, when they are executed by a computer, lead the computer to implement the method according to claim 1.
